(19) United States
(12) Patent Application Publication
(10) Pub. No.: US 2026/0031427 A1
(43) Pub. Date: Jan. 29, 2026

(54) HEAT EXCHANGER

(71) Applicant: CALYOS SA, JUMET (BE)

(72) Inventors: Vincent DUPONT, AUDERGHEM (BE); Cyrille BILLET, ROSSEIGNIES (BE); Antoine DE RYCKEL, CHARLEROI (BE)

(21) Appl. No.: 19/099,810

(22) PCT Filed: Apr. 19, 2023
(86) PCT No.: PCT/EP2023/060193

§ 371 Date: Jan. 30, 2025

(30) Foreign Application Priority Data
Aug. 3, 2022 (FR) FR2208073

(51) Int. Cl. H01M 10/6552; H01M 10/613; H01M 10/625; H01M 10/6551

(52) U.S. Cl. CPC H01M 10/6552; H01M 10/613; H01M 10/625; H01M 10/6551; H01M 2220/20

(57) ABSTRACT

A heat exchanger including a body containing a working fluid and including a first manifold and a second manifold; at least one internal partition being arranged in the body to form at least two internal channels, each internal channel being in fluid communication with the first manifold and with the second manifold; the body being intended to be thermally coupled to a cold source at a first part and to a hot source at a second part, the first part and the second part being connected by an elbow part; and wherein each internal channel has a cross-section in which the dimensions are adapted so that the working fluid contained in the internal channel has an Eötvös number Eo that is less than or equal to 2.

### CROSS REFERENCE TO RELATED APPLICATIONS

This application is a National Stage of International Application No. PCT/EP2023/060193, having an international filing date of 19 Apr. 2023, which designated the United States of America, and which International Application was published under PCT Article 21 (2) as WO Publication No. 2024027962, which claims priority from and the benefit of French Patent Application No. 2208073 filed on 3 Aug. 2022, the disclosures of which are incorporated herein by reference in their entireties.

### BACKGROUND

### 1. Field

This description relates to a heat exchanger. This description also relates to a battery comprising such a heat exchanger.

### 2. Brief Description of Related Developments

The cooling of electronic devices increasingly involves cooling systems based on two-phase working fluid. These have good heat transfer efficiency, plus a low temperature gradient. To achieve this, an evaporator is placed on heating elements, a condenser is placed on a heat sink, and a two-phase working fluid circulates between the evaporator and the condenser.

Among these systems, first are the known heat pipes. A heat pipe is in the form of a hermetic enclosure that contains a two-phase fluid, i.e. in liquid and gaseous form. One end of the heat pipe is located near the heating elements (this end is commonly called the “evaporator”, and the element to be cooled the “hot source”). At the evaporator, the fluid in the liquid state vaporizes by absorbing thermal energy emitted by the hot source. The vapor then flows through the heat pipe to the other end (commonly called the condenser) located at a heat sink (commonly called the “cold source”) where it condenses to return to the liquid state. Condensation allows thermal energy to be released to the cold source.

The liquid must then return to the evaporator. To do this, the heat pipe may be oriented so that the liquid returns to the evaporator due to the force of gravity. However, this means that the arrangement of the heat pipe is greatly limited by its orientation relative to gravity. Alternatively, pumping may be provided by means of capillary forces, using structures (porous, grooved, grids, etc.). However, in this case, the operation of the heat pipe depends on the proper operation of the pumping element, which can affect the reliability of the heat pipe.

Oscillating heat pipes (also called “pulsating” heat pipes) are also known. This type of heat pipe is in the form of a serpentine tube. The tube is partially filled with a two-phase liquid comprising a succession of vapor bubbles and liquid slugs. When a portion of the oscillating heat pipe is heated and another is cooled (the heated portion being in fluid communication with the cooled portion), the triggered boiling and the resulting saturation temperature differences generate fluctuations in local pressures. These fluctuations transform each liquid slug into a piston which, on average, pushes the vapor bubbles towards the subcooled zones. This stochastic movement is called oscillation and allows transferring the associated heat from the superheated zone to the subcooled zone. An oscillating heat pipe is thus a passive system, in that it does not require an external mechanical element to ensure its operation. However, an oscillating heat pipe in serpentine form has the disadvantage of being bulky and difficult to arrange in a system to be cooled. In addition, the manufacture of such an oscillating heat pipe is expensive.

The present description aims in particular to provide a simple, economical, and effective solution to the problems mentioned above, making it possible to avoid the disadvantages of the known technique.

### SUMMARY

A heat exchanger is proposed which comprises:
a body defining an interior volume which is hermetically sealed to the outside and contains a determined amount of a two-phase working fluid, the body comprising a first manifold at a first end and a second manifold at a second end;
at least one internal partition arranged in the body to form at least two internal channels in the body, each internal channel being in fluid communication with the first manifold and with the second manifold;
the exchanger comprising at least a first part and a second part, the body being intended to be thermally coupled to a cold source at the first part and to a hot source at the second part, the first part and second part being connected to each other by at least one elbow part forming a bend angle between the first part and the second part; and
wherein each internal channel has a cross-section in which the dimensions are adapted so that the working fluid contained in the internal channel has an Eötvös number Eo that is less than or equal to 2 with Eo−(Δρ*g*Dh²)/σ where
Δρ is the difference in density between the working fluid in the liquid state and the working fluid in the vapor state;
g is the gravitational acceleration or the acceleration of a vehicle on which the exchanger is mounted;
Dh is the hydraulic diameter of the internal channel; and
σ is the surface tension.

Surprisingly, due to the angled shape of the internal channels and the dimensions of the internal channels, the heat exchanger has a dynamic operation between a first operating mode referred to as “conventional heat pipe” and a second operating mode referred to as “oscillating heat pipe”, depending on the inclination of the first part relative to the direction of the gravity field.

The first part and/or the second part may each be straight. The first part may extend rectilinearly from the first end in a first longitudinal direction and/or the second part may extend rectilinearly from the first end in a second longitudinal direction.

A first angle (a) is defined which corresponds to the angle formed between the first longitudinal direction and the direction of the Earth's gravity field. The first angle is equal to 0° when the first longitudinal direction is coincident with the direction of the gravity field and when the first end of the body is located vertically below the second end. Conversely, the first angle is equal to 180° when the first longitudinal direction is coincident with the direction of the gravity field and when the first end of the body is located vertically above the second end.

Similarly, a second angle (b) is defined which corresponds to the angle formed between the second longitudinal direction and the direction of the Earth's gravity field. The second angle is equal to 0° when the second longitudinal direction is coincident with the direction of the gravity field and when the second end of the body is located vertically below the first end. Conversely, the second angle is equal to 180° when the second longitudinal direction is coincident with the direction of the gravity field and when the second end of the body is located vertically above the first end.

According to a first configuration in which the first angle is between 90° and 180° (inclusive of both endpoints) and the second angle is between 0° and 90° (inclusive of both endpoints), the heat exchanger operates according to a first mode in which the circulation of the working fluid in liquid form in each internal channel from the first part to the second part results from the force of gravity.

According to a second configuration in which the first angle is between 0° (inclusive) and 90° (exclusive) and the second angle is between −90° and 0° (inclusive of both endpoints), the heat exchanger operates according to a second mode referred to as “oscillating” (“Pulsating Heat Pipe” or “Oscillating Heat Pipe”, commonly referred to by the acronym PHP or OHP) in which the circulation of the working fluid in each internal channel takes place in an oscillatory motion of a succession of vapor bubbles and liquid slugs. The oscillatory motion results primarily from surface tension forces between the working fluid in liquid and vapor form and from triggered boiling, creating saturation temperature differences that generate local pressure fluctuations in the fluid. The operation of the heat exchanger in the second mode is all the more surprising since known oscillating heat pipes are generally in the form of a single closed serpentine loop partially filled with a heat transfer fluid, while the heat exchanger here comprises a plurality of internal channels, each being in fluid communication with a first manifold and a second manifold.

Such a heat exchanger therefore has the advantage of operating, i.e. performing a heat exchange between the cold source and the hot source by the circulation of the two-phase working fluid inside the body, for a wide range of inclinations of the first part of the exchanger relative to the Earth's gravity field. In particular, the working fluid in liquid form generated in the first part (in particular at the cold source) flows towards the second part (i.e. towards the hot source) even when the first part is arranged with the first end downwards (i.e. when the first angle is between 0° and) 90° and although the force of gravity opposes circulation in this direction of the working fluid in liquid form, i.e. operating against gravity. In addition, the exchanger is without any pumping element (pump, porous structure, etc.) and moving parts, which makes it reliable and economical.

As a result, the heat exchanger has the advantage of being able to be easily arranged in systems to be cooled, since constraints concerning the inclination of the first part of the exchanger are reduced, but it is also able to be arranged in mobile systems to be cooled where the orientation relative to the acceleration field is variable.

Also, it has been observed that the heat exchanger has similar performances to those of a “conventional” heat pipe when it operates according to the first operating mode (measured thermal resistance of about 0.16 and 0.3 K/W). Furthermore, the heat exchanger also has satisfactory performances when it operates according to the second operating mode (measured thermal resistance of about 0.3 and 0.6 K/W).

The heat exchanger may comprise between six and twenty-four internal channels. It is not excluded that the exchanger may comprise fewer than nine or more than twelve internal channels.

The working fluid contained in the hermetic body may be at saturation. The working fluid has a saturation temperature which sets the pressure in the system. The saturation temperature is between the temperature of the cold source and a maximum admissible temperature of the hot source. For example, the saturation temperature may be between −50° C. and +200° C. For example, the saturation pressure may be between 0.3 kPa and 2000 kPa. The temperature and pressure of the working fluid may be made to vary within the space within the body and over time, in particular during operation in the second operating mode. A mean saturation temperature and a mean saturation pressure may therefore be defined. The density of the working fluid may be determined at a pressure and temperature corresponding to the mean saturation pressure and the mean saturation temperature.

The working fluid may be a heat transfer fluid, in particular trans-1-Chloro-3,3,3-trifluoropropene (R1233zd(E)) which has the advantage of being dielectric and non-flammable. It is not excluded that other heat transfer fluids may be used. Non-exhaustively, the working fluid may also be water, R1336mzz, methanol, acetone, toluene, HFE7200, or HFE7500. The body is filled with working fluid to a fill percentage which may be between 20% and 80%.

Each channel may have a cross-section that is rectangular in shape. The hydraulic diameter of each internal channel may be less than or equal to 6 mm, preferably less than or equal to 1.8 mm in the case of R1233zd(E). Non-exhaustively, each internal channel may also have a cross-section that has the shape of a square, diamond, oval, circle, moon, or crescent. Depending on the particular case, each internal channel may have a cross-section with a first circular part and a second rectangular or diamond-shaped part.

In equivalent terms, the first part may form, in whole or in part, a condenser, and the second part may form an evaporator.

The bend angle θ formed between the first part and the second part may be greater than or equal to 90°. Such a heat exchanger is thus more compact. In other words, the space occupied by the exchanger is reduced. Integration of the heat exchanger into a system to be cooled is therefore easier. The bend angle may be coincident with an angle formed between the first longitudinal direction and the second longitudinal direction. A bend radius of the elbow part may be defined, this being greater than a minimum bend radius so as to avoid excessive deformation of the body which could impact its durability.

The body may comprise a first main wall and a second main wall which face each other in a first transverse direction, the first main wall and the second main wall being connected by two side walls spaced apart from each other in a second transverse direction such that the body has an elongate profile in the second transverse direction. The body thus has a shape that allows easily accommodating the heat exchanger inside a system to be cooled, in particular between two elements when the system comprises a series of elements to be cooled arranged one after the other. The heat exchanger then allows more local and therefore more efficient cooling. For example, the heat exchanger may be adapted to be inserted between two adjacent cells 100 of a vehicle battery. The two side walls may be rounded. This facilitates manufacturing the body by extrusion. The first main wall and/or the second main wall may be thermally coupled to the cold source at the first part of the exchanger. The first main wall and/or the second main wall may be thermally coupled to the hot source at the second part of the exchanger.

The first main wall and the second main wall may be substantially planar. The first transverse direction and the second transverse direction may be perpendicular to each other. The first transverse direction and the second transverse direction may be perpendicular to the main direction of extension of the body. In other words, the first transverse direction and the second transverse direction may be perpendicular to the first longitudinal direction at the first part of the exchanger and perpendicular to the second longitudinal direction at the second part of the exchanger.

Alternatively, the first main wall and the second main wall may be substantially rounded, about an axis extending in the main direction of extension of the body. Such an exchanger may thus be arranged around a system to be cooled that is of cylindrical shape, such as cylindrical battery cells for example. The first main wall and the second main wall may be substantially rounded, respectively about an axis extending in the first direction at the first part of the exchanger and in the second direction at the second part of the exchanger. In this case, the first transverse direction may be coincident with a radial direction relative to the axis extending in the main direction of extension of the exchanger. Also, the second transverse direction may be coincident with a circumferential direction relative to the axis extending in the main direction of extension of the exchanger. The curvature of the first main wall and of the second main wall may be limited to a determined area of the body, which may be limited for example to the condenser. According to one particular example, the first main wall and the second main wall may be rounded about an axis extending in the main direction of extension of the body so as to have a circular cross-section. The internal channels are then arranged in an annular space formed between the first main wall and the second main wall.

At each internal channel, the first main wall and the second main wall may be spaced apart from each other in the first transverse direction by a first distance that is less than or equal to 2.5 mm with a tolerance of 0.15 mm. In other words, the heat exchanger may have a thickness that is less than or equal to 2.5 mm with a tolerance of 0.15 mm. The exchanger therefore advantageously has a low thickness.

Each internal partition may comprise a first end and a second end in the first transverse direction. The first end and the second end of each internal partition may be respectively connected to the first main wall and the second main wall. Each internal partition may have a dimension in the first transverse direction which is coincident with the distance which separates the first main wall and the second main wall. Each internal partition may be made as one piece with the first main wall and/or the second main wall.

The first main wall and the second main wall may be joined at the first end of the body and at the second end of the body so as to seal the body closed. The first main wall and the second main wall may be deformed, for example by seal welding or punching, so that they are brought to abut against each other in the first transverse direction. The distance in the first transverse direction which separates the first main wall and the second main wall may vary between 0 and the first distance in at least a portion of each of the manifolds.

The first manifold and the second manifold may be produced by machining the internal partitions so that they are shortened at each end of the body and thus form a space (i.e. the manifold) at each end of the body, with which all the internal channels are in communication.

The first main wall and the second main wall may be secured to each other at the first end of the body and at the second end of the body, in particular by welding. This may be, for example, ultrasonic welding or TIG welding. Alternatively, the exchanger may comprise a cap covering the first main wall and the second main wall at the first end of the body and at the second end of the body and secured to the first main wall and/or the second main wall. The system may be produced by additive manufacturing in its entirety or simply at the caps.

The internal channels may be arranged one after the other in the second transverse direction.

The first main wall and the second main wall may respectively have, in at least the second part of the exchanger, a first thermal conductivity coefficient and a second thermal conductivity coefficient which are different from each other. This encourages locally triggered boiling at the wall which has the highest thermal conductivity coefficient, which makes it easier to set the working fluid in motion within the body, even in the presence of a low power density from the hot source.

In one particular case, the first main wall and/or the second main wall may comprise a strip extending respectively in the first longitudinal direction and the second longitudinal direction, for each portion of the body, at which the walls respectively have the first thermal conductivity coefficient and the second thermal coefficient.

Each internal partition may have, at least in part, a third thermal conductivity coefficient which may be between the first thermal conductivity coefficient and the second thermal conductivity coefficient. In particular, the third thermal conductivity coefficient may be equal to the first thermal conductivity coefficient or to the second thermal conductivity coefficient. Alternatively, each internal partition may have at least one portion whose thermal resistance is greater than the thermal resistance of the first main wall and of the second main wall. By locally increasing the thermal resistance between the two main walls, the movement of the working fluid is further facilitated. Also, each internal partition may be made of the same material as the main walls in order to maintain the same properties. The local increase in thermal resistance may be obtained by a different degree of sintering. The portion of the partition having a higher thermal resistance may be porous (but without permitting a significant hydraulic connection between the channels).

According to one alternative, each internal partition may comprise a first portion and a second portion which are arranged one after the other in the first transverse direction, the first portion being adjacent to the first main wall and the second portion being adjacent to the second main wall. The first portion of each internal partition may have the first thermal conductivity coefficient and the second portion of each internal partition may have the second thermal conductivity coefficient. In one particular case, the first portion and the second portion of each internal partition may extend in the first transverse direction, to a relative dimension that is equal to 50% of the dimension of the internal partition in the first transverse direction.

The first main wall, the second main wall, and/or each internal partition may be made of the same preferably conductive material. This may be aluminum or copper. Indeed, aluminum is an inexpensive material which has a good thermal conductivity coefficient. The heat exchanger may thus be produced by a process of extruding a profile section.

Alternatively, the first main wall, the second main wall, and/or each internal partition may be made of different materials. For example, the first main wall and the second main wall may be made of a first material and each internal partition may be made of a second material. According to another example, the first main wall and each internal partition may be made of a first material and the second main wall may be made of a second material. The heat exchanger may be manufactured by additive manufacturing or by melt joining. In addition, the first main wall, the second main wall, and/or each internal partition may comprise a coating, in particular adapted to modify the thermal conductivity coefficient locally.

At least one internal channel may comprise, in at least the second part of the exchanger, at least two sub-channels, preferably in a portion of the second part of the exchanger which is thermally coupled to the hot source. It has been found that increasing the number of channels at the second part relative to the first part allows improving the performance of the exchanger by reducing the hydraulic diameter and increasing the internal exchange surface area. According to one particular case, each internal channel comprises at least two sub-channels.

The exchanger may further comprise at least one fin extending from an outer face of the body at the first part, the exchanger preferably comprising a plurality of fins extending from said outer face of the body. The exchanger may comprise a plurality of fins extending from an outer face of the first main wall of the body at the first part and/or from an outer face of the second main wall of the body at the first part.

According to one alternative, the exchanger may comprise an intermediate part. The exchanger may comprise a first elbow part connecting the first part to the intermediate part and a second elbow part connecting the second part to the intermediate part. For example, the angle formed by each elbow part may be equal to 90°. The intermediate part may therefore extend perpendicularly to the first part and to the second part. In other words, the first part and second part may extend parallel to each other. This “L” configuration may be generalized to form “T” or “X” shaped systems.

The body may comprise at least a first piece and a second piece which are attached to each other, each internal channel being arranged inside the first piece and the first manifold being formed by the second piece.

According to another aspect, a battery is provided comprising at least two cells and the heat exchanger as described above, the second part of the heat exchanger being interposed between the two cells. This may be a battery for a vehicle. The heat exchanger may be integrated into all four sides of a single extruded profile section to form a two-phase housing as one piece.

### BRIEF DESCRIPTION OF THE FIGURES

Other features, details and advantages will become apparent upon reading the detailed description below, and upon analyzing the attached drawings, in which:

FIG. 1 shows a perspective view of an exchanger according to the present description;

FIG. 2 shows a cross-section view of the exchanger of FIG. 1;

FIG. 3 shows a longitudinal section view, along a plane perpendicular to a first transverse direction, of two separate portions of the exchanger of FIG. 1;

FIG. 4 shows a longitudinal section view, along a plane perpendicular to a second transverse direction, of an end portion of the exchanger of FIG. 1;

FIG. 5 shows a perspective view of the integration of the exchanger of the figure into a system to be cooled;

FIG. 6 shows a longitudinal section view, along a plane perpendicular to the second transverse direction, of the exchanger of FIG. 1;

FIG. 7 schematically represents the operating mode of the exchanger of the figure as a function of its inclination relative to the gravitational field;

FIG. 8 shows a longitudinal section view, along a plane perpendicular to the second transverse direction, of the exchanger of FIG. 1 according to an alternative aspect;

FIG. 9 includes FIGS. 9a to 9c which each represent a cross-section view of the exchanger of FIG. 1 according to other alternative aspects;

FIG. 10 shows a partial longitudinal section view, along a plane perpendicular to the first transverse direction, of the exchanger of FIG. 1 according to another alternative aspect;

FIG. 11 includes FIGS. 11a to 11c, which each represent a partial cross-section view of the exchanger of FIG. 1 according to other alternative aspects;

FIG. 12 includes FIGS. 12a to 12c, which each represent a partial cross-section view of the exchanger of FIG. 1 according to other alternative aspects;

FIG. 13 represents a perspective view of the exchanger of FIG. 1 according to another alternative aspect;

FIG. 14 represents a partial longitudinal view of the exchanger of FIG. 1 according to another alternative aspect.

### DETAILED DESCRIPTION

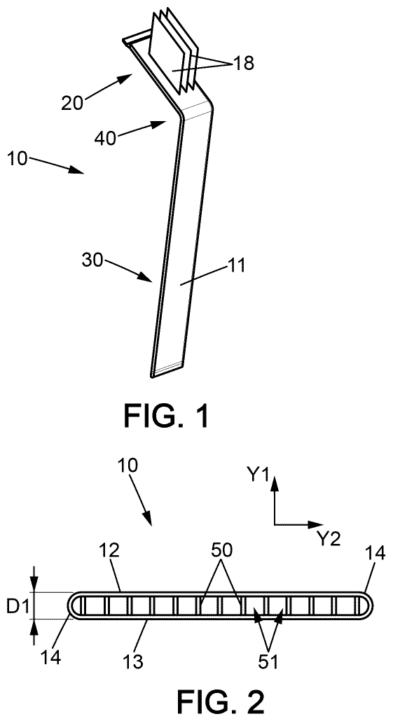

Reference is now made to FIGS. 1 to 7 which show a heat exchanger 10 according to a preferred aspect. FIGS. 8 to 14 show alternative implementations of the aspect of FIGS. 1 to 7.

Heat exchanger 10 firstly comprises a body 11 defining an interior volume which is hermetically sealed to the outside and contains a determined amount of a two-phase working fluid. Body 11 comprises a first main wall 12 and a second main wall 13 arranged facing each other in a first transverse direction Y1. First main wall 12 and second main wall 13 are also connected by two side walls 14 spaced apart from each other in a second transverse direction Y2 such that body 11 has an elongate profile in second transverse direction Y2.

Body 11 also comprises a first manifold 21 at a first end and a second manifold 31 at a second end. Exchanger 10 further comprises a plurality of internal partitions 50 arranged in body 11 to form at least a plurality of internal channels 51 in body 11. Exchanger 10 here comprises twelve internal channels 51. Preferably, the heat exchanger 10 comprises between nine and twelve internal channels 51. It is not excluded that exchanger 10 may comprise fewer than nine or more than twelve internal channels 51. Internal channels 51 are arranged one after the other in second transverse direction Y2. Each internal partition 50 comprises a first end and a second end along first transverse direction Y1, which are respectively connected to first main wall 12 and second main wall 13. Each internal partition 50 here is integral with first main wall 12 and second main wall 13. Each internal channel 51 is in fluid communication with first manifold 21 and with second manifold 31. In other words, each internal channel 51 leads into first manifold 21 and into second manifold 31. It is therefore understood that the internal volume of body 11 comprises first manifold 21, a tubular internal volume defined by each internal channel 51, and second manifold 31.

The working fluid is a heat transfer fluid, such as trans-1-Chloro-3,3,3-trifluoropropene (R1233zd(E)) which has the advantage of being dielectric and non-flammable. It is not excluded that other heat transfer fluids may be used. Non-exhaustively, the working fluid may also be water, R1336mzz, methanol, acetone, toluene, ethyl lactate, HFE7200, or HFE7500. Body 11 is filled with working fluid to a fill percentage that may be between 20% and 80%. The working fluid contained in hermetic body 11 may be at saturation. The working fluid may therefore have a saturation temperature and a saturation pressure. The saturation temperature may be between the temperature of cold source 22 and a maximum admissible temperature of hot source 32. For example, the saturation temperature may be between −50° C. and +200° C. For example, the saturation pressure may be between 0.3 kPa and 2000 kPa.

It is noteworthy in FIGS. 1 and 6 that exchanger 10 comprises at least a first part 20 and a second part 30. Body 11 is intended to be thermally coupled to a cold source 22 at first part 20 and to a hot source 32 at second part 30. The application and extraction of heat may also take place on only one of the two active faces shown. In equivalent terms, first part 20 forms, here in part, a condenser and second part 30 forms, also in part, an evaporator. First part 20 and second part 30 are connected to each other by at least one elbow part 40 forming a bend angle θ between first part 20 and second part 30. First part 20 of exchanger 10 therefore comprises first manifold 21 and a first part 51a of each internal channel 51. Second part 30 of exchanger 10 comprises second manifold 31 and a second part 51b of internal channel 51. Each internal channel 51 therefore comprises a portion at elbow part 40. In short, each internal channel 51 has an elbow shape as well.

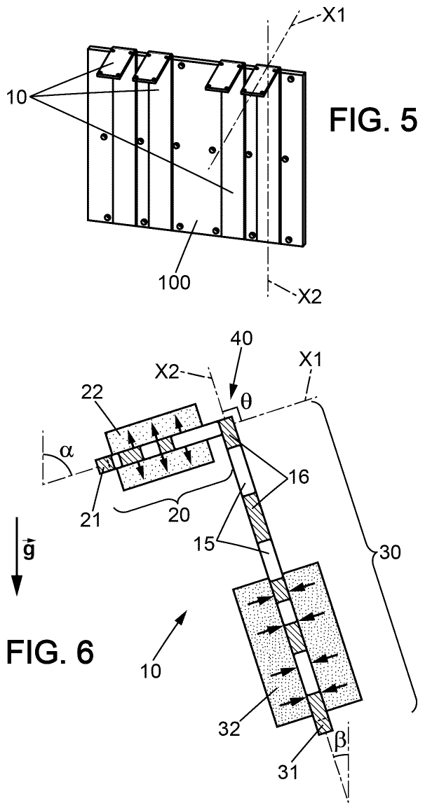

For example, as shown in FIG. 5, heat exchanger 10 is adapted to be inserted between two adjacent cells 100 of a vehicle battery. Second part 30 of exchanger 10 here is adapted to be inserted, or even clamped, between battery cells 100 so as to capture the heat emitted by them. First part 20 of exchanger 10 may then be arranged externally to the battery, in particular along the battery, so as to transfer the heat to the ambient air or to a water block so as to prevent water from entering the volume containing the batteries. Heat exchanger 10 allows more local and therefore more efficient cooling from the core of the battery.

In the example illustrated, first part 20 and second part 30 are straight. In other words, exchanger 10 has a main direction of extension at each of first part 20 and second part 30. Thus, body 11 and each internal partition 50 extend rectilinearly in a first longitudinal direction X1 at first part 20 of exchanger 10 (first main direction of extension). Similarly, body 11 and each internal partition 50 extend rectilinearly in a second longitudinal direction X2 at second part 30 of exchanger 10 (second main direction of extension).

Bend angle θ therefore is coincident with an angle formed between first longitudinal direction X1 and second longitudinal direction X2. In the example illustrated in FIGS. 1 to 7, bend angle θ is equal to 90°. With reference to FIG. 8, according to one variant, it may be provided that bend angle θ formed between first part 20 and second part 30 is greater than 90°. Such a heat exchanger 10 is thus more compact. In other words, the “footprint” required by exchanger 10 is reduced. The integration of heat exchanger 10 into a system to be cooled is therefore easier. A bending radius of elbow part 40 may be defined, being greater than a minimum bending radius so as to avoid excessive deformation of body 11 which could impact its durability.

Each internal channel 51 has a cross-section (considered perpendicularly to the main direction of extension of exchanger 10) whose dimensions are adapted so that the working fluid contained in internal channel 51 has an Eötvös number Eo that is less than or equal to 2, with Eo=(Δρ*g*Dh²)/σ where
Δρ is the difference in density between the working fluid in the liquid state and the working fluid in the vapor state;
g is the gravitational acceleration or the acceleration of a vehicle on which exchanger 10 is mounted;
Dh is the hydraulic diameter of internal channel 51; and
σ is the surface tension.

Thus, surprisingly, due to the elbow shape of internal channels 51 and the dimensions of internal channels 51, the operation of heat exchanger 10 is dynamic between a first operating mode referred to as “conventional heat pipe” and a second operating mode referred to as “oscillating heat pipe”, depending on the inclination of first part 20 relative to the direction of the gravity field \vec{g}. In the first mode, liquid accumulates in part 20 and the system quickly ceases its nominal operation.

As shown in FIG. 6, a first angle α is defined which corresponds to the angle formed between first longitudinal direction X1 and the direction of Earth's gravity field \vec{g}. First angle α is equal to 0° when first longitudinal direction X1 is coincident with the direction of the gravity field \vec{g} and when the first end of body 11 is located below the second end in the vertical direction (or in other words, in a low position). Conversely, first angle α is equal to 180° when first longitudinal direction X1 is coincident with the direction of the gravity field \vec{g} and when the first end of body 11 is located above the second end in the vertical direction (or in other words, in a high position). Similarly, a second angle β is defined which corresponds to the angle formed between second longitudinal direction X2 and the direction of Earth's gravity field \vec{g}. Second angle β is equal to 0° when second longitudinal direction X2 is coincident with the direction of the gravity field \vec{g} and when the second end of body 11 is located below the first end in the vertical direction (or in other words, in a low position). Conversely, second angle β is equal to 180° when second longitudinal direction X2 is coincident with the direction of the gravity field \vec{g} and when the second end of body 11 is located above the first end in the vertical direction (or in other words, in a high position).

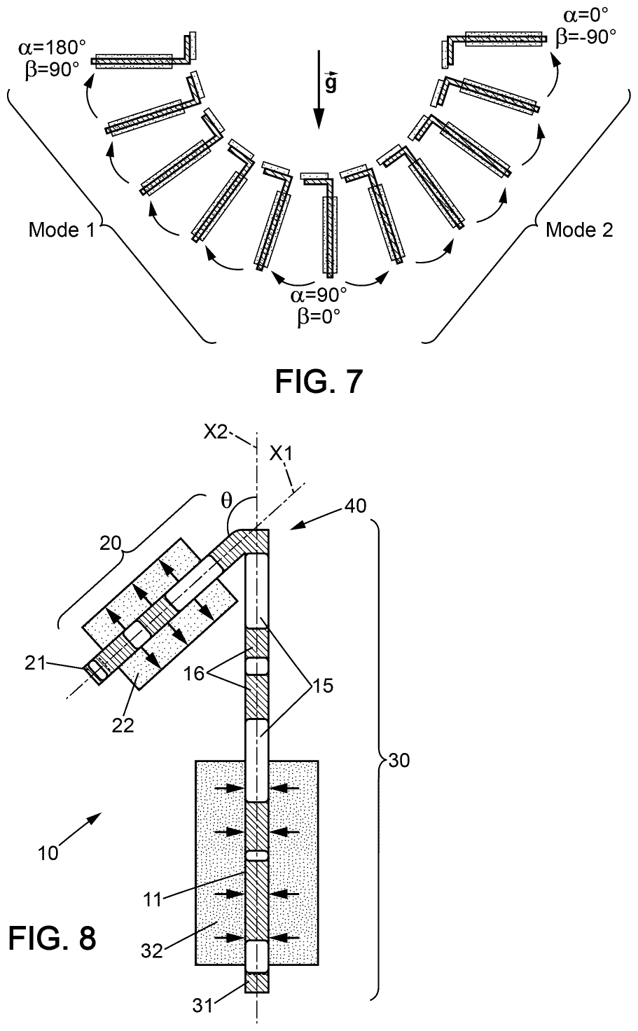

The operating mode of exchanger 10 according to the inclination of first part 20 relative to the direction of the gravity field \vec{g} is shown in FIG. 7. According to a first configuration in which first angle α is between 90° and 180° (inclusive of both endpoints) and second angle β is between 0° and 90° (inclusive of both endpoints), heat exchanger 10 operates according to a first mode (Mode 1) in which the circulation of the working fluid in liquid form in each internal channel 51 from first part 20 to second part 30 results mainly from the force of gravity \vec{g}.

According to a second configuration in which first angle α is between 0° (inclusive) and 90° (exclusive) and second angle β is between −90° and 0° (inclusive of both endpoints), heat exchanger 10 operates only in a second mode (Mode 2) referred to as “oscillating” (“Pulsating Heat Pipe” or “Oscillating Heat Pipe”, commonly referred to by the acronym PHP or OHP) in which the circulation of the working fluid in each internal channel 51 takes place according to an oscillatory movement of a succession of vapor bubbles 15 and liquid slugs 16. The oscillatory movement results mainly from the surface tension forces between the working fluid in liquid form and in vapor form and from the triggered boiling which creates differences in the saturation temperature, generating local pressure fluctuations in the fluid.

It is not excluded that exchanger 10 operates in the second mode when it is in the first configuration.

Nevertheless, the operation of heat exchanger 10 in the second mode is all the more surprising since known oscillating heat pipes are generally in the form of a single closed serpentine loop partially filled with a heat transfer fluid, while here heat exchanger 10 comprises a plurality of internal channels 51, each being in fluid communication with a first manifold 21 and a second manifold 31.

Furthermore, such a heat exchanger 10 therefore has the advantage of operating, i.e. carrying out a heat exchange between cold source 22 and hot source 32 by the circulation of the two-phase working fluid inside body 11, for a wide range of inclinations of first part 20 of exchanger 10 relative to Earth's gravity field \vec{g}. In particular, the working fluid in liquid form generated in first part 20 (in particular at cold source 22) flows towards second part 30 (i.e. towards hot source 32) even when first part 20 is arranged with the first end downwards (i.e. when first angle α is between 0° and 90°) and even though the force of gravity \vec{g} opposes the flow in this direction of the working fluid in liquid form. In addition, exchanger 10 is without any pumping element (pump, porous structure, etc.) or moving parts, which makes it reliable and economical to manufacture and implement.

As a result, heat exchanger 10 has the advantage of being able to be easily arranged in systems to be cooled since the constraints on the inclination of first part 20 of exchanger 10 are reduced, but also has the advantage that it may be arranged in mobile systems to be cooled having a variable orientation relative to the gravity field \vec{g}.

Also, it has been observed that the performance of heat exchanger 10 is similar to that of a “conventional” heat pipe when it operates in the first operating mode (measured resistance of around 0.16 and 0.3 K/W). Furthermore, heat exchanger 10 also performs well when it operates in the second operating mode (measured resistance of around 0.3 and 0.6 K/W).

The temperature and pressure of the working fluid may be made to vary within the space within body 11 and over time, in particular when operating in the second operating mode. An average saturation temperature and an average saturation pressure may therefore be defined. The densities and surface tension of the working fluid taken into account in the Eötvös number Eo may be determined for a pressure and temperature corresponding to the average saturation pressure and the average saturation temperature.

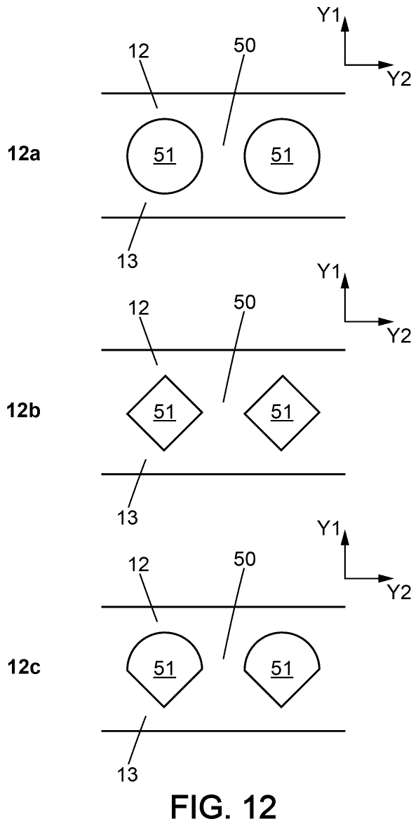

Each channel may have a cross-section having the shape of a rectangle as shown in FIG. 2. The hydraulic diameter of each internal channel 51 may be less than or equal to 6 mm, preferably less than or equal to 1.8 mm when the working fluid is R1233zd(E). Alternatively, as can be seen in FIG. 12a, each internal channel 51 may also have a cross-section having the shape of a circle. According to another alternative shown in FIG. 12b, each internal channel 51 may also have a cross-section having a diamond shape. In a non-exhaustive manner, and not shown, each internal channel 51 may also have a section having a square, oval, moon, or crescent shape. According to a particular case shown in FIG. 12c, each internal channel 51 may have a cross-section having a first part 20 of circular shape (or semi-circular, i.e. the side forms an arc of a circle) and a second part in the shape of a half-diamond (the obtained shape is also called a “teardrop” shape). According to another particular case, not shown, each internal channel 51 may have a cross-section having a first part 20 of circular shape (or semi-circular, i.e. the side forms an arc of a circle) and a second part in the shape of a half-rectangle (the obtained shape is also called a “tunnel” shape).

Finally, it is not excluded that two internal channels 51 have respective cross-sections which differ from each other in their shape.

As can be seen in FIG. 2, first main wall 12 and second main wall 13 here are substantially planar. Also, first transverse direction Y1 and second transverse direction Y2 are perpendicular to each other. First transverse direction Y1 and second transverse direction Y2 are perpendicular to the main direction of extension of body 11. Thus, first transverse direction Y1 and second transverse direction Y2 are perpendicular to first longitudinal direction X1 at first part 20 of exchanger 10 and are perpendicular to second longitudinal direction X2 at second part 30 of exchanger 10.

At each internal channel 51, first main wall 12 and second main wall 13 are spaced apart from each other in first transverse direction Y1, by a first distance DI that is less than or equal to 2.5 mm with a tolerance of 0.15 mm. In other words, heat exchanger 10 may have a thickness that is less than or equal to 2.5 mm with a tolerance of 0.15 mm. Exchanger 10 therefore advantageously has a small thickness. Each internal partition 50 may have a dimension along first transverse direction Y1 that is coincident with first distance DI separating first main wall 12 and second main wall 13.

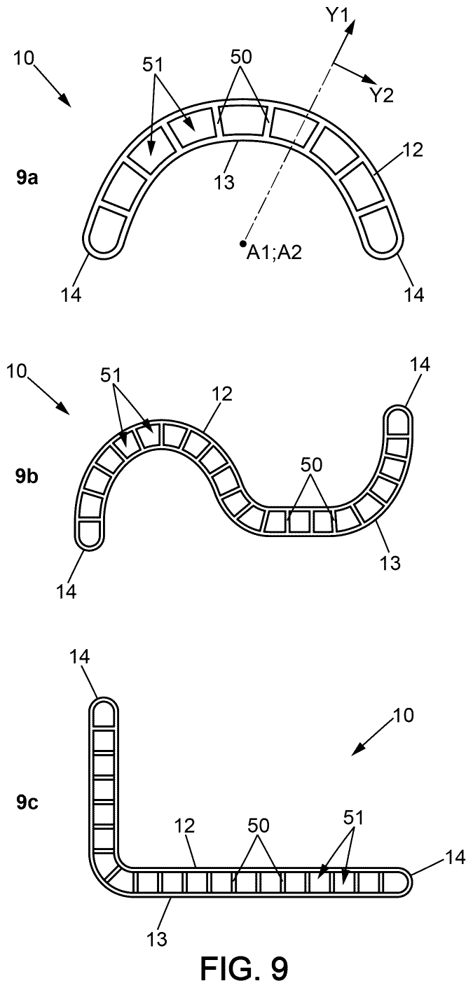

Alternatively, as shown in FIG. 9a, first main wall 12 and second main wall 13 may be substantially rounded, about an axis extending along the main direction of extension of body 11. Exchanger 10 therefore has a cross-sectional shape that is in the form of an arc of a circle around its main direction of extension. Such an exchanger 10 may thus be arranged around a system (e.g. a battery cell 100) to be cooled that is cylindrical in shape. In particular, at first part 20 of exchanger 10, first main wall 12 and second main wall 13 may respectively be substantially rounded, about a first axis Al extending along first longitudinal direction X1. Similarly, at second part 30 of exchanger 10, first main wall 12 and second main wall 13 may respectively be substantially rounded, about a second axis A2 extending in second longitudinal direction X2. In this case, first transverse direction Y1 may be coincident with a radial direction relative to the axis extending in the main direction of extension of exchanger 10 (i.e. first axis Al at first part 20 and second axis A2 at second part 30). In addition, second transverse direction Y2 may be coincident with a circumferential direction relative to the axis extending in the main direction of extension of exchanger 10 (i.e. first axis Al at first part 20 and second axis A2 at second part 30).

According to other aspects illustrated in FIGS. 9b and 9c, first main wall 12 and second main wall 13 may each have a cross-sectional shape that is a double curved surface (FIG. 9b) or an L-shape (FIG. 9c).

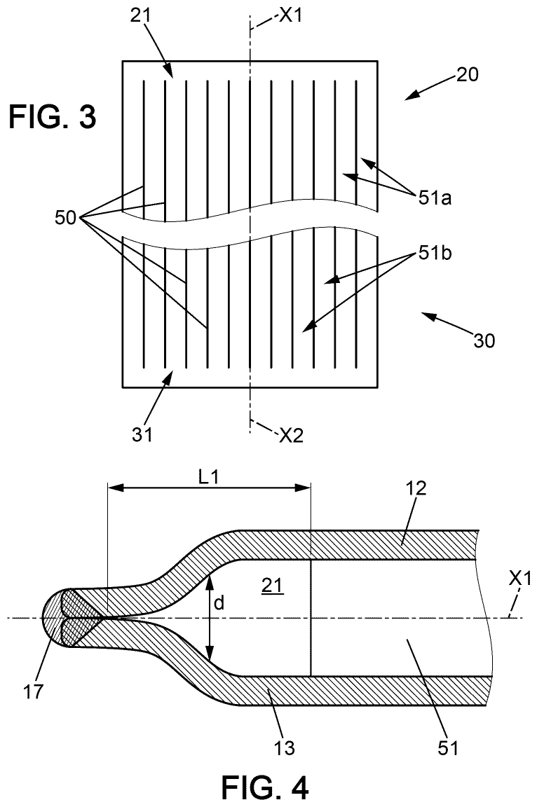

Reference is now made more particularly to FIG. 4. It is noteworthy that first main wall 12 and second main wall 13 are joined at the first end of body 11 so as to seal body 11 closed. Similarly, and not shown, first main wall 12 and second main wall 13 are joined at the second end of body 11 so as to seal body 11 closed. To do this, first main wall 12 and second main wall 13 here are in a deformed state at each end, so that they are brought to abut against each other in first transverse direction Y1. The deformation of first main wall 12 and the second main wall may for example be obtained by seal welding or punching. As a result, the distance in first transverse direction Y1 which separates first main wall 12 and second main wall 13 may be zero at each end and increase in at least a portion of each of manifolds 21, 31 so as to be equal to first distance DI and thus ensure a good hydraulic connection between all internal channels 51.

First main wall 12 and second main wall 13 here are furthermore secured to each other at the first end of body 11 and the second end of body 11. In the example illustrated, first main wall 12 and second main wall 13 are secured by a weld 17. This may be for example an ultrasonic weld or a TIG weld. According to one variant, not shown, exchanger 10 may comprise a cap which covers first main wall 12 and second main wall 13 at the first end of body 11 and the second end of body 11 so as to close off the interior volume of body 11 at each end. Furthermore, the cap may be secured to first main wall 12 and/or second main wall 13.

When manufacturing exchanger 10, each internal partition 50 may initially extend inside body 11 from the first end to the second end of body 11. First manifold 21 and second manifold 31 may then be produced by machining internal partitions 50 over a length LI at each end of body 11 and thus form a space (i.e. the manifold) at each end of body 11, with which all internal channels 51 are in communication.

First main wall 12, second main wall 13, and each internal partition 50 may be made of the same material. This may be aluminum. Indeed, aluminum is an inexpensive material that has a good thermal conductivity coefficient. Heat exchanger 10 may thus be produced by a process of extruding a profile section.

According to an alternative aspect, with reference to FIGS. 1la to 11c, first main wall 12 and second main wall 13 have, at least at second part 30 of exchanger 10, respectively a first thermal conductivity coefficient and a second thermal conductivity coefficient which are different from each other. This encourages locally triggered boiling at the wall which has the highest thermal conductivity coefficient, which makes it easier to set the working fluid in motion within body 11, even in the presence of a low power density from hot source 32. For this purpose, first main wall 12 and second main wall 13 may be made of different materials. According to one alternative, not shown, first main wall 12 and/or second main wall 13 may each comprise a strip extending respectively in first longitudinal direction X1 and second longitudinal direction X2, at which the walls respectively have the first thermal conductivity coefficient and the second thermal coefficient.

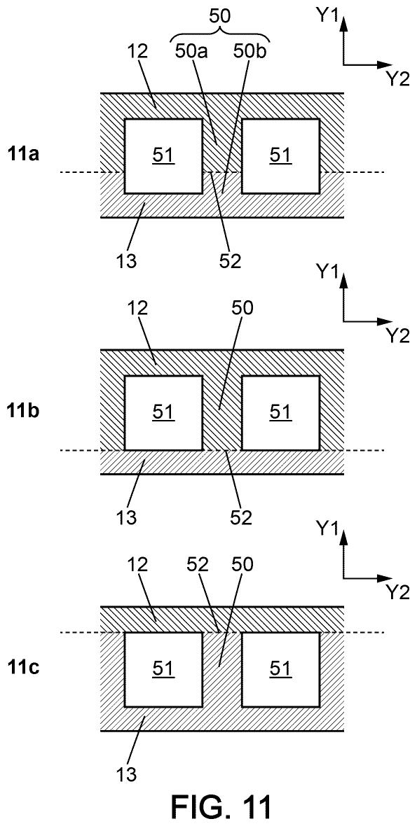

Each internal partition 50 may also have a third thermal conductivity coefficient which is between the first thermal conductivity coefficient and the second thermal conductivity coefficient. In the example of FIG. 11b, the third thermal conductivity coefficient is equal to the first thermal conductivity coefficient of first main wall 12. Each internal partition 50 may be made for example of the same material as first main wall 12. In the example of FIG. 11c, the third thermal conductivity coefficient is equal to the second thermal conductivity coefficient of second main wall 13. Each internal partition 50 may then be made of the same material as the second main wall.

In the example of FIG. 1la, each internal partition 50 comprises a first portion 50a and a second portion 50b which are arranged one after the other in first transverse direction Y1, first portion 50a being adjacent to first main wall 12 and second portion 50b being adjacent to second main wall 13. First portion 50a of each internal partition 50 has the first thermal conductivity coefficient, and second portion 50b of each internal partition 50 has the second thermal conductivity coefficient. First portion 50a of each internal partition 50 may be made of the same material as that in which first main wall 12 is made. Similarly, second portion 50b of each internal partition 50 may be made of the same material as that in which second main wall 13 is made. In one particular case, first portion 50a and second portion 50b of each internal partition 50 may for example extend in first transverse direction YI to a relative dimension equal to 50% of the dimension of internal partition 50 in first transverse direction Y1. As another alternative, first main wall 12, second main wall 13, and each internal partition 50 may be made of different materials. Such a heat exchanger 10 may be manufactured by additive manufacturing or by melt joining. In addition, first main wall 12, second main wall 13, and/or each internal partition 50 may also comprise a coating, in particular adapted to modify the thermal conductivity coefficient locally.

Each internal partition 50 comprises a zone 52 acting as an interface between the first thermal conductivity coefficient and the second thermal conductivity coefficient. Zone 52 of each internal partition 50 may have a locally higher thermal resistance compared to the thermal resistance of first main wall 12 and second main wall 13, so as to further facilitate the movement of the working fluid in exchanger 10.

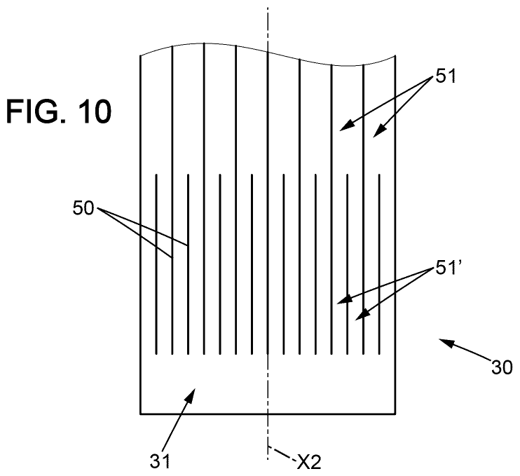

According to another variant aspect, shown in FIG. 10, each internal channel 51 may comprise two sub-channels 51′ at second part 30 of exchanger 10, preferably at a portion of second part 30 of exchanger 10 which is thermally coupled to hot source 32. It has been found that increasing the number of channels at second part 30 relative to first part 20 allows improving the performance of exchanger 10. According to one alternative, not shown, a channel may comprise more than two sub-channels 51′. According to another alternative, not shown, it may be provided that certain internal channels 51 comprise sub-channels 51′ at second part 30 of exchanger 10, and other internal channels 51 are without any sub-channels 51′ (i.e. they are not subdivided).

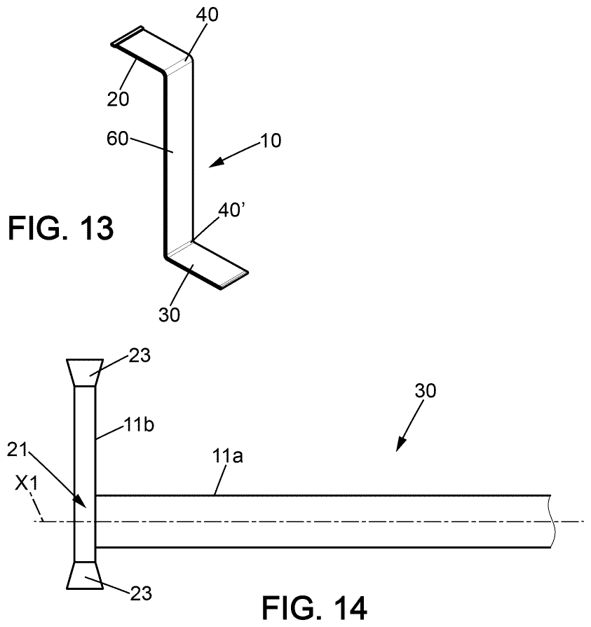

According to another variant aspect, shown in FIG. 13, exchanger 10 comprises an intermediate part 60. Exchanger 10 comprises a first elbow part 40 connecting first part 20 to intermediate part 60 and a second elbow part 40′ connecting second part 30 to intermediate part 60. Here, the angle formed by each elbow part 40, 40′ is equal to 90°. Intermediate part 60 therefore extends perpendicularly to first part 20 and to second part 30. As was already mentioned, the angle formed by each elbow part 40, 40′ may be greater than 90°. Also, first part 20 and second part 30 extend parallel to each other such that an axis extending in first longitudinal direction X1 is coplanar with an axis extending in second longitudinal direction X2. Alternatively, first part 20 and second part 30 may extend parallel to each other such that an axis extending in first longitudinal direction X1 is not coplanar with an axis extending in second longitudinal direction X2.

According to another variant aspect, shown in FIG. 14, body 11 may comprise at least a first piece 11a and a second piece 11b which are attached to each other. Each internal channel 51 is arranged inside first piece 11a. First manifold 21 is formed by second piece 11b. According to this variant, an interior volume of first part 11a therefore comprises the tubular internal volume of each internal channel 51 and an interior volume of second piece 11b comprises first manifold 21. First piece 11a and second piece 11b are in fluid communication. First piece 11a comprises a first tube in the form of a profile section extending in the main direction of extension of exchanger 10. Second piece 11b comprises a second tube extending perpendicularly to first longitudinal direction X1. Each end 23 of the second tube is closed off, for example by being crushed and welded. Such an arrangement makes it possible to avoid machining to form the first manifold inside a profile section. In addition, second piece 11b may form a first manifold shared by a plurality of exchangers identical to exchanger 10 as described above. Similarly, the body may comprise a third piece forming second manifold 31.

What is claimed is:

1. A heat exchanger comprising:
a body defining an interior volume which is hermetically sealed to the outside and contains a determined amount of a two-phase working fluid, the body comprising a first manifold at a first end and a second manifold at a second end;
at least one internal partition arranged in the body to form at least two internal channels in the body, each internal channel being in fluid communication with the first manifold and with the second manifold;
the exchanger comprising at least a first part and a second part, the body being intended to be thermally coupled to a cold source at the first part and to a hot source at the second part, the first part and the second part being connected to each other by at least one elbow part forming a bend angle between the first part and the second part; and
wherein each internal channel has a cross-section in which the dimensions are adapted so that the working fluid contained in the internal channel has an Eötvös number Eo that is less than or equal to 2 with Eo−(Δρ*g*Dh²)/σ where
Δρ is the difference in density between the working fluid in the liquid state and the working fluid in the vapor state;
g is the gravitational acceleration or the acceleration of a vehicle on which the exchanger is mounted;
Dh is the hydraulic diameter of the internal channel; and
σ is the surface tension.

2. Heat The heat exchanger according to claim 1, wherein the bend angle formed between the first part and the second part is greater than or equal to 90°.

3. The heat exchanger according to claim 1, wherein the body comprises a first main wall and a second main wall which face each other in a first transverse direction, the first main wall and the second main wall being connected by two side walls spaced apart from each other in a second transverse direction such that the body has an elongate profile in the second transverse direction.

4. The heat exchanger according to claim 3, wherein, at each internal channel, the first main wall and the second main wall are spaced apart from each other in the first transverse direction by a first distance that is less than or equal to 2.5 mm with a tolerance of 0.15 mm.

5. The heat exchanger according to claim 3, wherein the first main wall and the second main wall are joined at the first end of the body and at the second end of the body so as to seal the body closed.

6. The heat exchanger according to claim 3, wherein the first main wall and the second main wall respectively have, in at least a portion of the second part of the exchanger, a first thermal conductivity coefficient and a second thermal conductivity coefficient which are different from each other.

7. The heat exchanger according to claim 1, wherein at least one internal channel comprises, in at least a portion of the second part, at least two sub-channels.

8. The heat exchanger according to claim 1, the exchanger further comprising at least one fin extending from an outer face of the body at the first part.

9. The heat exchanger according to claim 1, wherein the body comprises at least a first piece and a second piece which are attached to each other, each internal channel being arranged inside the first piece and the first manifold being formed by the second piece.

10. A battery comprising at least two cells and the heat exchanger according to claim 1, the second part of the heat exchanger being interposed between the two cells.

11. The heat exchanger according to claim 1, wherein at least one internal channel comprises at least two sub-channels in a portion of the second part of the exchanger which is thermally coupled to the hot source.

12. The heat exchanger according to claim 1, the exchanger further comprising a plurality of fins extending from said outer face of the body.
